(19) United States
(12) Patent Application Publication
(10) Pub. No.: US 2018/0218308 A1
(43) Pub. Date: Aug. 2, 2018

(54) MODELING EMPLOYEE PRODUCTIVITY BASED ON SPEECH AND AMBIENT NOISE MONITORING

(71) Applicant: INTERNATIONAL BUSINESS MACHINES CORPORATION, Armonk, NY (US)

(72) Inventors: Kuntal Dey, New Delhi (IN); Munish Goyal, Yorktown Heights, NY (US); Qin S. Held, Midland Park, NJ (US); Sudhanshu S. Singh, New Delhi (IN)

(21) Appl. No.: 15/420,789

(22) Filed: Jan. 31, 2017

(51) Int. Cl. G06Q 10/06; H04L 29/08; G06F 17/50

(52) U.S. Cl. CPC G06Q 10/06393; G06F 17/5009; H04L 67/10

(57) ABSTRACT

A computer-implemented method includes: determining, by a computing device, mood states of one or more individuals within an observation zone over a period of time based on audio data received from one or more audio input devices implemented within the observation zone; determining, by the computing device, a deviation between the mood states and expected mood states; generating, by the computing device, a model representing the deviation; and providing, by the computing device, a visual representation of the model.

### BACKGROUND

The present invention generally relates to modeling employee productivity and, more particularly, to modeling employee productivity based on speech and ambient noise monitoring.

Employee productivity is a key metric tracked by employers of all sizes, ranging from small businesses to large corporations. Employee productivity and employee turnover rate is often linked to employee mood and employee emotional state. Employers utilize a variety of techniques to improve employee productivity, such as offering bonuses/promotions, paid time-off, flexible hours, organizing social gatherings, etc.

### SUMMARY

In an aspect of the invention, a computer-implemented method includes: determining, by a computing device, mood states of one or more individuals within an observation zone over a period of time based on audio data received from one or more audio input devices implemented within the observation zone; determining, by the computing device, a deviation between the mood states and expected mood states; generating, by the computing device, a model representing the deviation; and providing, by the computing device, a visual representation of the model.

In an aspect of the invention, there is a computer program product for predicting employee moods and corresponding productivity and turn over risk based on ambient audio in an observation zone. The computer program product includes a computer readable storage medium having program instructions embodied therewith, the program instructions executable by a computing device to cause the computing device to: monitor mood states of one or more individuals by monitoring ambient audio received from one or more audio input devices within the observation zone; establish an expected mood state profile based on the monitoring; determine a deviation between an actual mood state during a period of time and the expected mood state; generate a model representing at least one of the productivity and the turnover risk based on the deviation; and provide a visual representation of the model

In an aspect of the invention, a system includes: a CPU, a computer readable memory and a computer readable storage medium associated with a computing device; program instructions to determine mood states of one or more individuals within an observation zone over a period of time based on audio data received from one or more audio input devices implemented within the observation zone; program instructions to associated transitions between the mood states with events; program instructions to generate a model representing the transitions between the mood states as a function of the events; and program instructions to provide a visual representation of the model. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example implementation in accordance with aspects of the present invention

FIG. 5 shows an example environment in accordance with aspects of the present invention.

FIG. 6 shows a block diagram of example components of a productivity modeling system in accordance with aspects of the present invention.

FIG. 7 shows an example flowchart for predicting productivity and/or turnover risk based on determining and monitoring mood states from audio data in observation areas in accordance with aspects of the present invention.

FIG. 8 shows an example of a visual representation of transitions between different mood states in accordance with aspects of the present invention in accordance with aspects of the present invention.

FIG. 9 shows an example of a graph illustrating a mood and productivity model in accordance with aspects of the present invention.

### DETAILED DESCRIPTION

The present invention generally relates to modeling employee productivity and, more particularly, to modeling employee productivity based on speech and ambient noise monitoring. Aspects of the present invention may determine employee mood/emotional states based on audio data collected in an observation zone, such as an office. For example, aspects of the present invention may determine employee mood/emotional states based on employee speech, ambient noise, etc., present in the observation zone. Over a period of time, an expected mood profile is generated that identifies an expected mood state given a set of conditions. For example, the mood profile may identify an expected mood state during a time of year or after an event (e.g., a negative event, a performance bonus event, etc.). The expected mood profile may be continuously updated over the course of time, or may be generated for a specific time period. As described herein, a mood may be determined in terms of a description (e.g., “happy”, “unhappy,” “neutral” etc.) or in a terms of a numerical value (e.g., on a scale of 0-10 in which 0 represents the most negative mood whereas 10 represents the most positive mood).

As described herein, an actual mood (e.g., at current time or defined time period) may be determined based on speech and/or ambient audio from within an observation zone. The actual mood may be compared against the expected mood profile to determine a deviation between the current mood and expected mood. For example, aspects of the present invention may determine whether a current mood is relatively better or worse than the expected mood, and based on the deviation, short and long term mood labels may be assigned and used to model productivity and turnover risk over a period of time. Further, future emotional states and corresponding productivity/turn over risk may be predicted based on expected future events such that any adverse effects from a future event can be effectively mitigated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

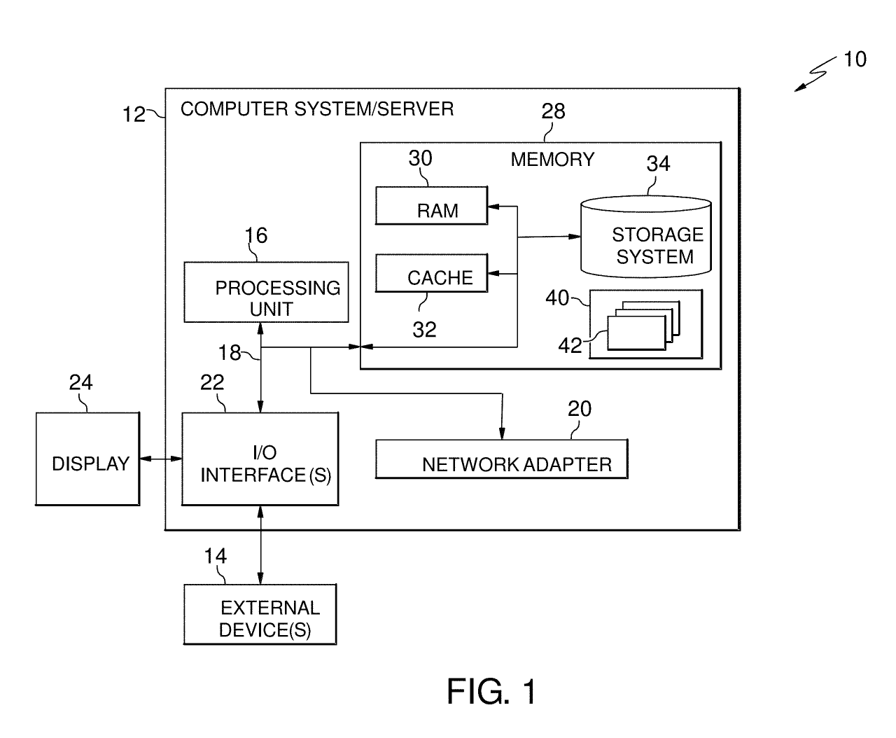

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

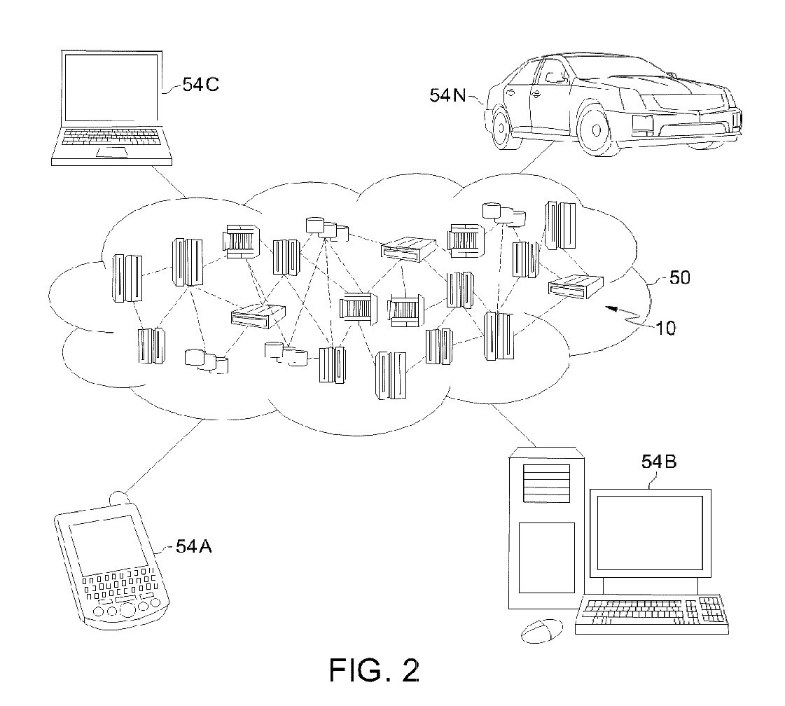

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

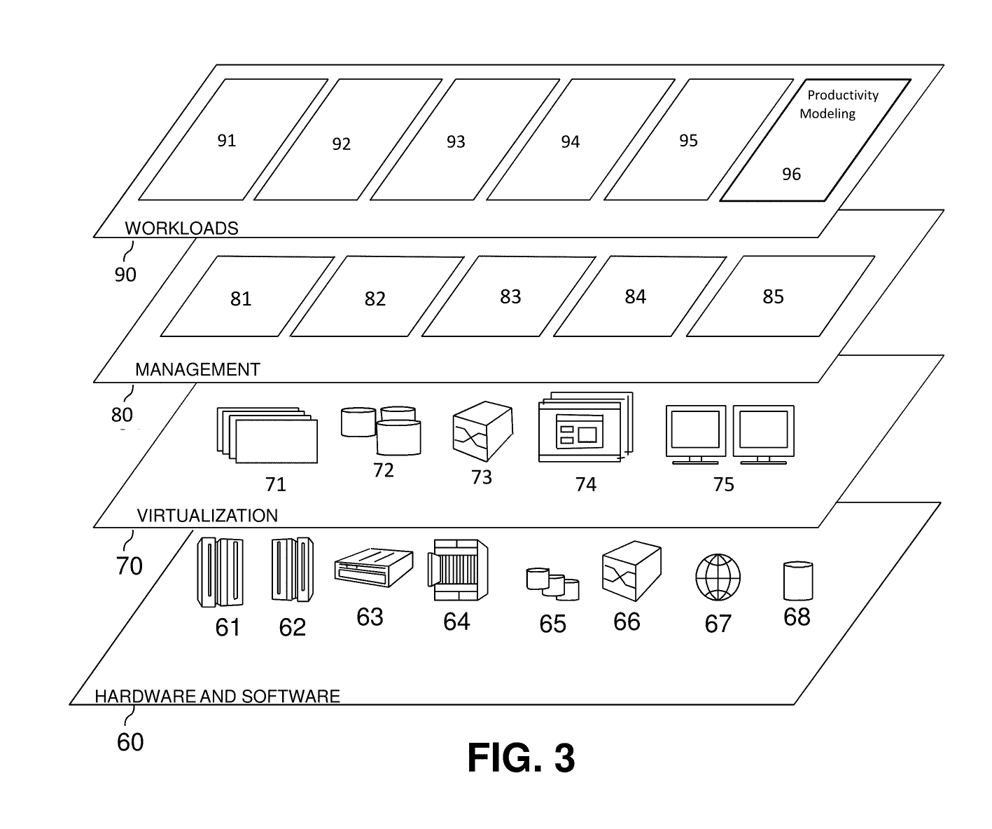

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and productivity modeling 96.

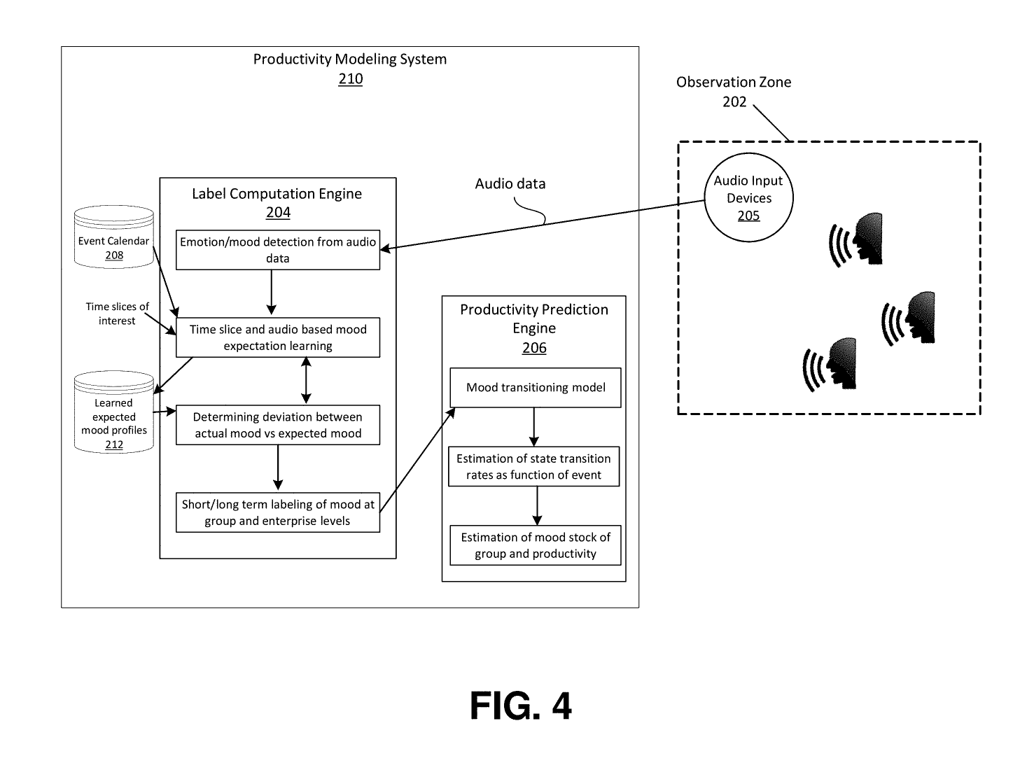

Referring back to FIG. 1, the program/utility 40 may include one or more program modules 42 that generally carry out the functions and/or methodologies of embodiments of the invention as described herein (e.g., such as the functionality provided by productivity modeling 96). Specifically, the program modules 42 may detect and monitor mood state from audio data, generate and maintain an expected mood profile, detect deviations between an actual mood state and an expected mood state, generate records identifying labels corresponding to the deviation, determine a mood stock from the generated records, generate a productivity model based on the mood stock, and output a visual display of the productivity model, actual mood state, expected mood state, and/or associated events. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of a productivity modeling system 210 as shown in FIG. 4.

FIG. 4 shows an overview of an example implementation in accordance with aspects of the present invention. As shown in FIG. 4, audio input devices 205 may be placed within an observation zone 202 (e.g., an office building or a selected location in which observation and monitoring of sentiment/mood is to take place, such as a cafeteria, lounge, etc.). The audio input devices 205 may provide audio data including speech, ambient noise, and/or other audio present in the observation zone 202 to a productivity modeling system 210. For example, the audio data may be received by a label computation engine 204 of the productivity modeling system 210. As described herein, the label computation engine 204 may determine short and long-term mood labels with which to associate the audio data.

As further shown in FIG. 4, the label computation engine 204 may detect emotions and/or moods from the audio data. For example, the label computation engine 204 may detect emotions and/or moods based on comparing audio prints and/or other audio data to mood profile data. Additionally, or alternatively, the label computation engine 204 may detect emotions and/or moods based on speech recognition and/or speech patterns identified from the audio data. As further shown in FIG. 4, the label computation engine 204 may learn and generate expected mood profiles based on the audio data. The expected mood profiles 212 may be organized by time periods (e.g., time slices) and events from a computer based event calendar 208. For example, the expected mood profiles 212 may identify an expected mood based on certain conditions (e.g., moods based on time periods and based on certain events, such as events relating to negative company events, performance bonuses, performance reviews, etc.). As further shown in FIG. 4, the label computation engine 204 may determine actual moods (e.g., during a particular time slice and after the occurrence of an event) and determine the deviation between the actual mood and an expected mood.

As further shown in FIG. 4, the label computation engine 204 may generate short-term and long-term labels representing the mood at a group level up to an enterprise or company-wide level. For example, the short-term label may identify the deviation between the actual mood and the expected mood for a certain period of time (e.g., one week), whereas the long-term label may identify the deviation between the actual mood and the expected mood after a longer defined period of time (one or several months). The short-term label may closely represent the actual mood at the time of analysis, whereas the long-term label may be based on a “normalization” rate in which mood may approach a “normal” or expected level after initially deviating from the expected level. In embodiments, the labels may be descriptive and/or numerical to represent the deviation between the actual mood and the expected mood. In embodiments, another label may be generated to describe the actual mood.

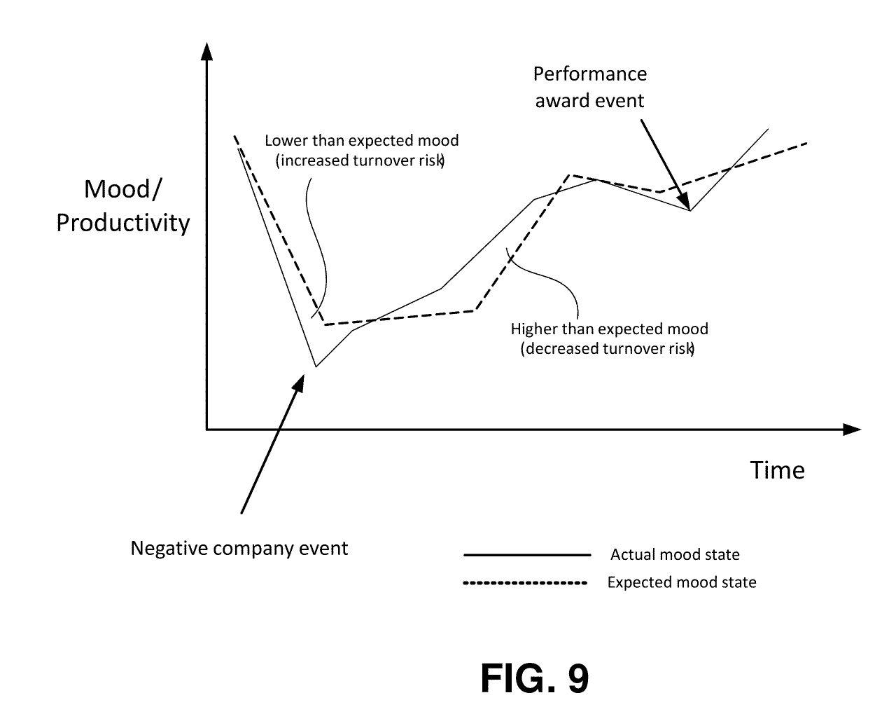

As further shown in FIG. 4, a productivity prediction engine of the productivity modeling system 210 may model mood transitioning data. For example, the productivity prediction engine 206 may model the events under which a mood transitioned from one state to another, and more specifically, the events under which a mood transitioned from a better-than-expected state to a worse-than-expected state. In embodiments, a Markov model may be used to capture the transition between the labeled states. The productivity prediction engine 206 may further estimate mood state transition rates as a function of event (e.g., to determine a cause of mood state transitions). The productivity prediction engine 206 may further estimate a “mood stock” which may correspond to a cumulative mood of a group of individuals over a period of time. From the mood stock, mood or employee sentiment maybe modeled, and correspondingly, productivity may also be modeled based on a correlation between mood and productivity. Further, deviations between actual mood and expected mood may be identified to determine higher and lower turnover risk during a period of time or after an event. A report may be generated and presented to visually display labels representing a deviation between actual and expected mood states (e.g., no deviation, better-than-expected mood, or worse-than-expected mood), the transition between the different deviation states, a productivity prediction, and/or a turnover risk prediction (e.g., as described in greater detail below with respect to FIG. 9). From the report, an employer may better prepare for situations in which employee sentiment is predicted to be lower than normal.

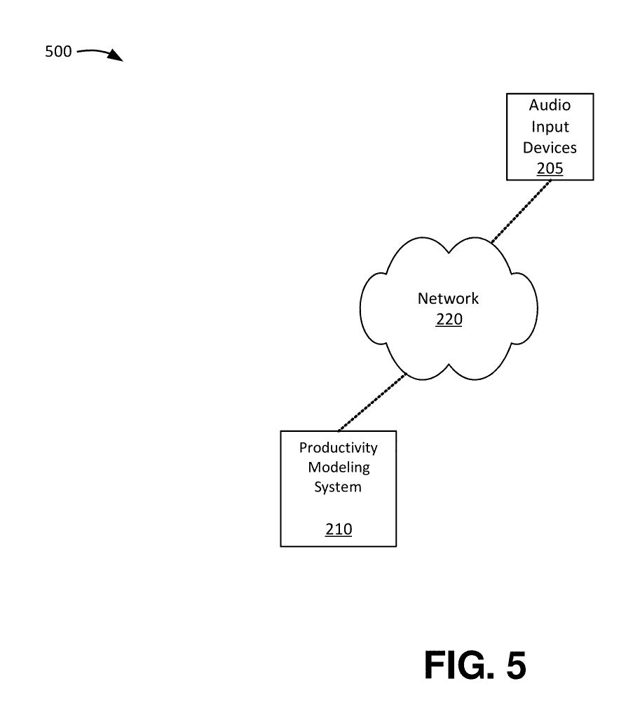

FIG. 5 shows an example environment in accordance with aspects of the present invention. As shown in FIG, 5, environment 500 may include audio input devices 205, productivity modeling system 210, and network 220. In embodiments, one or more components in environment 500 may correspond to one or more components in the cloud computing environment of FIG. 2. In embodiments, one or more components in environment 500 may include the components of computer system/server 12 of FIG. 1.

The audio input devices 205 may include microphones, sensors, and/or other audio capturing equipment. The audio input devices 205 may be implemented in an observation zone, such as a cafeteria, lounge, or the like for obtaining audio data that may be used to measure employee mood/sentiment. For example, the audio input devices 205 may be implemented to obtain speech and/or ambient noises that may indicate employee mood/sentiment.

The productivity modeling system 210 may include one or more computing devices, such as server devices (e.g., computer system/server 12 of FIG. 1) that obtains audio data from the audio input devices 205. As described herein the productivity modeling system 210 may detect and monitor mood state from audio data, generate and maintain an expected mood profile, detect deviations between an actual mood state and an expected mood state, generate records identifying labels corresponding to the deviation, determine a mood stock from the generated records, generate a productivity model based on the mood stock, and output a visual display/report of the productivity model, actual mood state, expected mood state, and/or associated events. From the visual display/report, an employer may better prepare for situations in which employee sentiment is predicted to be lower than normal.

The network 220 may include network nodes, such as network nodes 10 of FIG. 2. Additionally, or alternatively, the network 220 may include one or more wired and/or wireless networks. For example, the network 220 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 220 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 500 is not limited to what is shown in FIG. 5. In practice, the environment 500 may include additional devices and/or networks; fewer devices and/or networks; different devices and/or networks; or differently arranged devices and/or networks than illustrated in FIG. 5. Also, in some implementations, one or more of the devices of the environment 500 may perform one or more functions described as being performed by another one or more of the devices of the environment 500. Devices of the environment 500 may interconnect via wired connections, wireless connections, or a combination of wired and wireless connections.

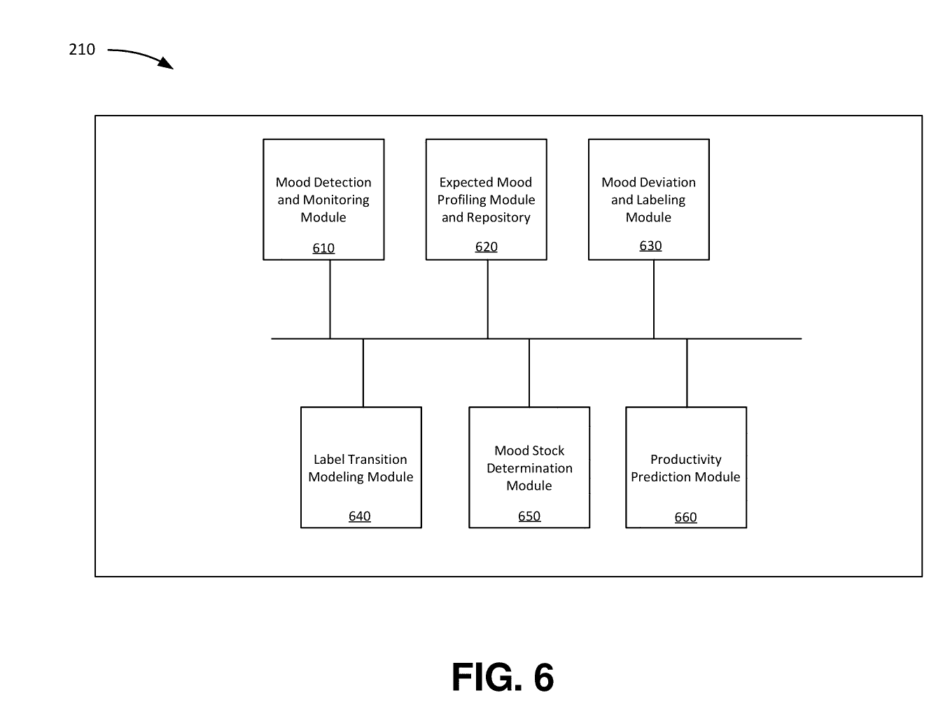

FIG. 6 shows a block diagram of example components of a productivity modeling system 210 in accordance with aspects of the present invention. As shown in FIG. 6, the productivity modeling system 210 may include a mood detection and monitoring module 610, an expected mood profiling module and repository 620, a mood deviation and labeling module 630, a label transition modeling module 640, a mood stock determination module 650, and a productivity prediction module 660. In embodiments, the productivity modeling system 210 may include additional or fewer components than those shown in FIG. 6. In embodiments, separate components may be integrated into a single computing component or module. Additionally, or alternatively, a single component may be implemented as multiple computing components or modules.

The mood detection and monitoring module 610 may include a program module (e.g., program module 42 of FIG. 1) that receives audio data from the productivity modeling system 210 and detects moods from the audio data. The mood detection and monitoring module 610 may detect emotions and/or moods based on comparing audio prints and/or other audio data to mood profile data. Additionally, or alternatively, the mood detection and monitoring module 610 may detect emotions and/or moods based on speech recognition and/or speech patterns identified from the audio data. The mood detection and monitoring module 610 may continue to monitor mood states throughout the process of aspects of the present invention. As described herein, a mood may be determined in terms of a description (e.g., “happy”, “unhappy,” “neutral” etc.) or in a terms of a numerical value (e.g., on a scale of 0-10 in which 0 represents the most negative mood whereas 10 represents the most positive mood). In embodiments, the mood detection and monitoring module 610 may be incorporated by the label computation engine 204 of FIG. 4.

The expected mood profiling module and repository 620 may include a data storage device and program module (e.g., storage system 34 and program module 42 of FIG. 1) that builds, updates, and maintains an expected mood profile over a period of time. For example, the expected mood profiling module and repository 620 may learn and generate an expected mood profile based on audio data received from the audio input devices 205. The expected mood profiles may be organized by time periods (e.g., time slices) and events from an event calendar (e.g., event calendar 208 of FIG. 4). For example, the expected mood profiles may identify an expected mood based on certain conditions (e.g., moods based on time periods and based on certain events, such as events relating to negative company events, performance bonuses, performance reviews, etc.). The expected mood profiling module and repository 620 may store the expected mood profile for comparison against actual moods. In embodiments, the expected mood profiling module and repository 620 may correspond to the learned expected mood profiles 212 of FIG. 4.

The mood deviation and labeling module 630 may include a program module (e.g., program module 42 of FIG. 1) that determines a deviation between an actual mood and an expected mood. For example, the mood deviation and labeling module 630 may obtain information regarding an actual mood from the mood detection and monitoring module 610. In embodiments, the mood deviation and labeling module 630 may obtain information regarding an actual mood during a past time period, or during a current time. The mood deviation and labeling module 630 may compare the actual mood with the expected mood based on an expected mood profile stored by the expected mood profiling module and repository 620. In embodiments, the mood deviation and labeling module 630 may be incorporated by the label computation engine 204 of FIG. 4.

In embodiments, the mood deviation and labeling module 630 may compare an expected mood profile against an actual mood with the same conditions (e.g., the same time of year, after a particular event, etc.). The mood deviation and labeling module 630 may also generate records with labels that identify the deviation between the actual mood and expected mood. For example, the mood deviation and labeling module 630 may generate records indicating a time period, the actual mood during the time period, the expected mood during the time period and the deviation between the actual and expected moods. As described in greater detail below, the records may be presented in a report and/or in graph format to visually illustrate predicted moods/deviations from expected moods, and corresponding productivity and/or turnover predictions. As described herein, the a label representing the deviation between an actual mood an expected mood may be in terms of a description (e.g., “better than expected,” “worse than expected” “as expected,” “louder than expected,” “quieter than expected,” etc.). For example, if the determined actual mood is more positive than expected, the label may be “better than expected,” whereas if the determined actual mood is more negative than expected, the label may be “worse than expected.” Also, if noise levels are less than expected, the label may be “quieter than expected” or “silent.” Additionally, or alternatively, the label may be in terms of a numerical value (e.g., on a scale of 0-10 in which 0 represents no deviation whereas 10 represents the highest degree of deviation).

The label transition modeling module 640 may include a program module (e.g., program module 42 of FIG. 1) that models the transition between labels (e.g., transition between mood states and/or transition between deviations in mood states). In embodiments, the label transition modeling module 640 may model the events under which a mood transitioned from one state to another, and more specifically, the events under which a mood transitioned from a better-than-expected state to a worse-than-expected state. In embodiments, a Markov model may be used to capture the transition between the labeled states. The label transition modeling module 640 may further estimate mood state transition rates as a function of event (e.g., to determine a cause of mood state transitions). In embodiments, the label transition modeling module 640 may be incorporated by the productivity prediction engine 206 of FIG. 4.

The mood stock determination module 650 may include a program module (e.g., program module 42 of FIG. 1) that determines a “mood stock” which may correspond to a cumulative mood of a group of individuals over a period of time. The mood stock determination module 650 may also determine a depletion rate or normalization rate in which the mood of individuals approaches an expected mood. As an illustrative analogy, the mood stock may be analogous to a fluid contained within a “leaky bucket” in which the mood stock eventually depletes thus returning the mood of a group of individuals back to a normal or expected mood. As a further illustration, a mood stock may initially be “unhappy” after an event (e.g., a negative event), however, the mood stock may “deplete” at a depletion or normalization rate such that eventually, the mood stock is fully depleted and a mood returns to a normal level. As described herein, the normalization rate may be estimated based on a maximum likelihood estimation technique and/or other technique. In embodiments, the mood stock determination module 650 may be incorporated by the productivity prediction engine 206 of FIG. 4.

The productivity prediction module 660 may include a program module (e.g., program module 42 of FIG. 1) that generates a prediction or model of productivity based on the mood stock, the deviation labels, the transition between mood states/deviation states, etc. For example, the productivity prediction module 660 may generate a model and/or a report visually illustrating the model including the labels representing a deviation between actual and expected mood states, the transition between the different deviation states, a productivity prediction, and/or a turnover risk prediction (e.g., as described in greater detail below with respect to FIG. 9). From the report, an employer may better prepare for situations in which employee sentiment is predicted to be lower than normal or lower than expected. In embodiments, the productivity prediction module 660 may be incorporated by the productivity prediction engine 206 of FIG. 4.

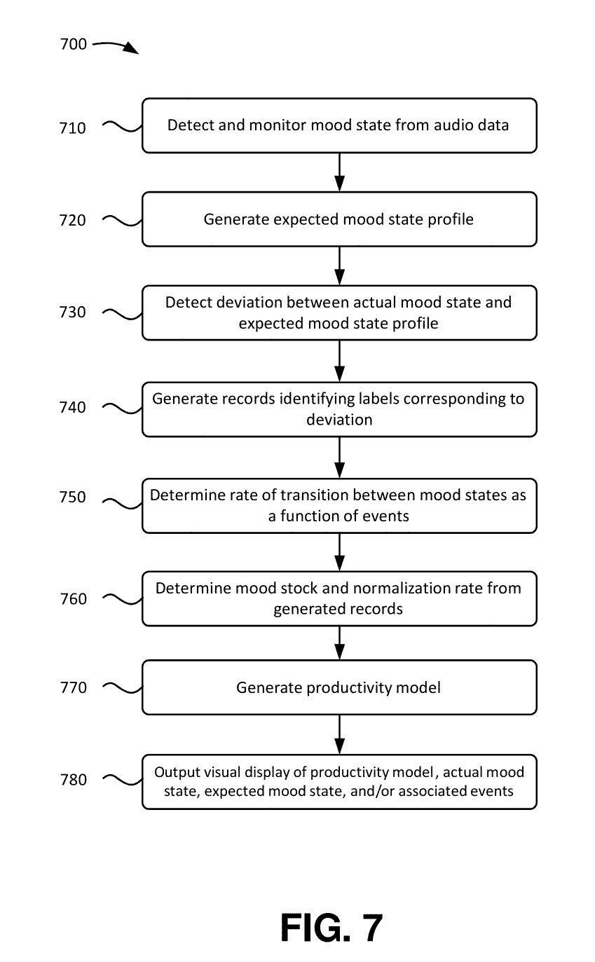

FIG. 7 shows an example flowchart of a process for predicting productivity and/or turnover risk based on determining and monitoring mood states from audio data in observation areas. The steps of FIG. 7 may be implemented in the environment of FIG. 4, for example, and are described using reference numbers of elements depicted in FIG. 4. As noted above, the flowchart illustrates the architecture, functionality, and operation of possible implementations of systems, methods, and computer program products according to various embodiments of the present invention.

As shown in FIG. 7, process 700 may include detecting and monitoring a mood state from audio data (step 710). For example, as described above with respect to the mood detection and monitoring module 610, the productivity modeling system 210 may detect emotions and/or moods based on comparing audio prints and/or other audio data to mood profile data. Additionally, or alternatively, the productivity modeling system 210 may detect emotions and/or moods based on speech recognition and/or speech patterns identified from the audio data. The productivity modeling system 210 may continue to monitor mood states throughout the process 700 as described herein.

Process 700 may further include generating an expected mood state profile (step 720). For example, as described above with respect to the expected mood profiling module and repository 620 the productivity modeling system 210 may build, update, and maintain an expected mood profile over a period of time. The productivity modeling system 210 may learn and generate an expected mood profile based on audio data received from the audio input devices 205. The expected mood profiles may be organized by time periods (e.g., time slices) and events from an event calendar.

Process 700 may also include detecting a deviation between the actual mood state and expected mood state profile (step 730). For example, as described above with respect to the mood deviation and labeling module 630 the productivity modeling system 210 may determine a deviation between an actual mood and an expected mood. For example, the productivity modeling system 210 may obtain information regarding an actual mood from the mood detection and monitoring module 610. In embodiments, the productivity modeling system 210 may obtain information regarding an actual mood during a past time period, or during a current time. The productivity modeling system 210 may compare the actual mood with the expected mood based on an expected mood profile stored by the expected mood profiling module and repository 620.

Process 700 may further include generating records identifying labels corresponding to the deviation (step 740). For example, as described above with respect to the mood deviation and labeling module 630 the productivity modeling system 210 may generate records with labels that identify the deviation between the actual mood and expected mood. For example, the mood deviation and labeling module 630 may generate records indicating a time period, the actual mood during the time period, the expected mood during the time period and the deviation between the actual and expected moods.

Process 700 may also include determining a rate of transition between the mood states as a function of events (step 750). For example, as described above with respect to the label transition modeling module 640 the productivity modeling system 210 may determine a rate of transition between the mood states as a function of events by modeling the events under which a mood transitioned from one state to another, and more specifically, the events under which a mood transitioned from a better-than-expected state to a worse-than-expected state. In embodiments, a Markov model may be used to capture the transition between the labeled states and to determine a rate of transition between the mood states as a function of events.

Process 700 may further include determining a mood stock and normalization rate from the generated records (step 760). For example, as described above with respect to the mood stock determination module 650 the productivity modeling system 210 may determines a “mood stock” which may correspond to a cumulative mood of a group of individuals over a period of time. The productivity modeling system 210 may also determine a depletion rate or normalization rate in which the mood of individuals approaches an expected mood. As described herein, the normalization rate may be estimated based on a maximum likelihood estimation technique and/or other technique.

Process 700 may further include generating a productivity model (step 770) and outputting a visual display of the productivity model, actual mood state, expected mood state, and/or associated events (step 780). For example, as described above with respect to the productivity prediction module 660 the productivity modeling system 210 may generate a prediction or model of productivity based on the mood stock, the deviation labels, the transition between mood states/deviation states, etc. For example, the productivity modeling system 210 may generate a model and output a report visually illustrating the model including the labels representing a deviation between actual and expected mood states, the transition between the different deviation states, the events associated with the different mood states, and a productivity prediction, and/or a turnover risk prediction (e.g., as described in greater detail below with respect to FIG. 9). From the report, an employer may better prepare for situations in which employee sentiment is predicted to be lower than normal or lower than expected.

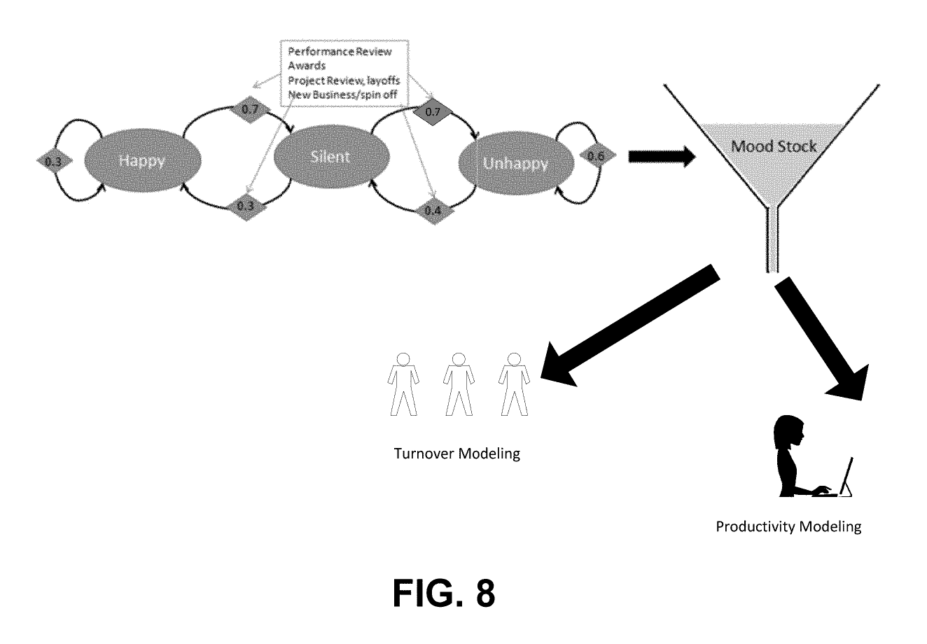

FIG. 8 shows an example of a visual representation of transitions between different mood states in accordance with aspects of the present invention. As shown in FIG. 8, the productivity modeling system 210 may provide a visual representation of transitions between different mood states. In the example of FIG. 8, the transition information shows three example mood states (e.g., “happy,” “silent,” and “unhappy”). Further, percentages are shown showing how often the mood transitioned from one state to another, or stayed the same. For example, when the mood state was “happy,” the mood state stayed the same 30% of the time (as represented by a value of 0.3), and transitioned to silent 70% of the time (as represented by a value of 0.7). Further, events are identified for each transition to identify the cause of the transition from one mood state to another. In embodiments, the illustration of FIG. 8 may illustrate the actual mood states or the deviation between actual and expected mood states. From the mood states (e.g. the actual or deviation), a mood stock may be generated (e.g., as illustrated by a fluid contained within a “leaky bucket” with a depletion or normalization rate). From the mood stock and/or the mood state transition information productivity and/or turnover risk models may be generated identifying periods of higher than expected turnover risk and/or periods of lower than expected productivity.

FIG. 9 shows an example of a graph illustrating a mood and productivity model in accordance with aspects of the present invention. As shown in FIG. 9, an actual mood state and an expected mood state may be graphed on a mood/productivity versus time line graph. Higher values on the y-axis may represent relatively higher or more positive moods (which may correlate with higher productivity). The graph of the actual mood state may represent values of the actual detected moods from audio data over a period of time (e.g., as described above with respect to process step 710 and mood detection and monitoring module 610). The graph of the expected mood state may represent values of the expected mood over the period of time from the mood profile (and with the same conditions under which the actual mood was detected). The graph of FIG. 9 may also identify events at particular times. For example, as shown in the example of FIG. 9, the actual mood state sharply declines at the time of a negative event. The expected mood state also declines, but to a lesser extent, thus creating a deviation between the actual mood state and the expected mood state as indicated. From the graph, it can be seen that during a period of time, a mood is lower than expected, and hence, an increased turnover risk is present, and lower productivity rates may also be present).

As further shown, the actual and expected mood states may slowly increase after the negative event. For example, the mood states may increase as a result of a mood normalization in which the mood states may approach a normalized level (e.g., as a mood stock depletes or normalizes). As shown in the example of FIG. 9, a period exists in which the actual mood state is better than the expected mood state, thereby representing potentially decreased turnover risk and higher-than-expected productivity. As further shown in the example of FIG. 9, another event (e.g., a performance award event) may cause the mood states to increase. As described, the graph of FIG. 9 provides a simple representation of actual mood in relation to expected mood such that lower-than-expected productivity and/or higher-than-expected turnover risk can be easily predicted and proactively addressed.

As described herein, aspects of the present invention provide a technique to define an “observation zone” around audio input devices 205, so that any sound/noise detected within this zone is easily associated with a group of employees as well as individual employees. Additionally, or alternatively, aspects of the present invention may detect voice and noise levels/emotions from voices, speech and/or other ambient noises created by individual employees as well as by groups of employees. Additionally, or alternatively, aspects of the present invention may observe and monitor the noise levels of each individual and each observation zone over a period of time, and learn the expected behavior at different periods of times (e.g., at different times of the day, days of the month, months of the year, occasions/events such as holidays, special events etc.), both for individual employees as well as combined for all the employees within the observation zone.

Aspects of the present invention may provide a technique to compute the deviation of a given mood/emotion (as deciphered by sound/noise level) from the learned/expected noise levels at similar points in time and under similar conditions (e.g., after the occurrence of a similar event). Additionally, or alternatively, aspects of the present invention may assign short-term labels (such as “silent”, “excited”, “happy”, “unhappy” etc.) to employees and groups of employees, by computing the direction of deviation (high/positive vs. low/negative) of a given noise and emotion level at a given location (observation zone) and point of time, with the expected levels at that location at that point of time. Additionally, or alternatively, aspects of the present invention may assign long-term labels to individual employees and groups of employees, with labels in terms of turnover propensity as well as with confidence scores associated with those labels (ex: “risk of turnover”, “risk of multiple employee turnover/group turnover” etc.) and a measured index of overall enterprise emotional health. Additionally, or alternatively, aspects of the present invention may estimate a rate of transition between mood states as function of organization's events such as negative company events, business news, performance reviews, rewards etc. Additionally, or alternatively, aspects of the present invention may predict group productivity as a function of measure mood stock value and the current event.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, by a computing device, mood states of one or more individuals within an observation zone over a period of time based on audio data received from one or more audio input devices implemented within the observation zone;
determining, by the computing device, a deviation between the mood states and expected mood states;
generating, by the computing device, a model representing the deviation; and
providing, by the computing device, a visual representation of the model.

2. The method of claim 1, wherein the deviation represents a change in mood or sentiment of the one or more individuals.

3. The method of claim 1, wherein the model representing the deviation further represents one of:
a productivity prediction of the one or more individuals; and
a turnover risk prediction of the one or more individuals.

4. The method of claim 1, further comprising continuously monitoring the mood states of the one or more individuals to generate an expected mood state profile, wherein the determining the deviation is based on generating the expected mood state profile.

5. The method of claim 1, further comprising:
determining a rate of transition between the mood states over the period of time as a function of events;
assigning a first label to a first one of the mood states based on the determining the mood states, wherein the first label indicates a description of the first one of the mood states over a first period of time;
assigning a second label to a second one of the mood states based on the determining the mood states, wherein the second label indicates a description of the second one of the mood states over a second period of time,
wherein the generating the model is further based on the determining the rate of transition between the mood states, the assigning the first label, and the assigning the second label.

6. The method of claim 5, further comprising determining a mood stock based on the determine the mood states of the one or more individuals, wherein the generating the model is further based on the mood stock.

7. The method of claim 5, wherein the visual representation of the model identifies transitions between the mood states and the events associated with the transitions.

8. The method of claim 5, wherein the visual representation of the model includes a graph representing values of the mood states and the expected mood state over the period of time.

9. The method of claim 8, wherein the graph identifies the deviation between the mood states and expected mood states.

10. The method of claim 1, wherein a service provider at least one of creates, maintains, deploys and supports the computing device.

11. The method of claim 1, wherein the determining the mood states, the determining the deviation, the generating the model, and the providing the visual representation are provided by a service provider on a subscription, advertising, and/or fee basis.

12. The method of claim 1, wherein the computing device includes software provided as a service in a cloud environment.

13. The method of claim 1, further comprising deploying a system for predicting employee moods and corresponding productivity based on the audio data, comprising providing a computer infrastructure operable to perform the determining the mood states, the determining the deviation, the generating the model, and the providing the visual representation.

14. A computer program product for predicting employee moods and corresponding productivity and turn over risk based on ambient audio in an observation zone, the computer program product comprising a computer readable storage medium having program instructions embodied therewith, the program instructions executable by a computing device to cause the computing device to:
monitor mood states of one or more individuals by monitoring ambient audio received from one or more audio input devices within the observation zone;
establish an expected mood state profile based on the monitoring;
determine a deviation between an actual mood state during a period of time and the expected mood state;
generate a model representing at least one of the productivity and the turnover risk based on the deviation; and
provide a visual representation of the model.

15. The computer program product of claim 14, wherein the deviation represents a change in mood or sentiment of the one or more individuals.

16. The computer program product of claim 14, wherein the program instructions further cause the computing device to determine a rate of transition between mood states over the period of time as a function of events, wherein the generating the model is further based on the determining the rate of transition between the mood states.

17. The computer program product of claim 16, wherein the program instructions further cause the computing device to determine a mood stock based on the determine the mood states of the one or more individuals, wherein the generating the model is further based on the mood stock.

18. The computer program product of claim 16, wherein the visual representation of the model includes a graph representing values of the mood states and the expected mood state over the period of time.

19. A system comprising:
a CPU, a computer readable memory and a computer readable storage medium associated with a computing device;
program instructions to determine mood states of one or more individuals within an observation zone over a period of time based on audio data received from one or more audio input devices implemented within the observation zone;
program instructions to associated transitions between the mood states with events;
program instructions to generate a model representing the transitions between the mood states as a function of the events; and
program instructions to provide a visual representation of the model
wherein the program instructions are stored on the computer readable storage medium for execution by the CPU via the computer readable memory.

20. The system of claim 19, further comprising program instructions to determine a deviation between an actual mood state during a period of time and an expected mood state, wherein generating the model is based on determining the deviation.
